(19) United States
(12) Patent Application Publication
(10) Pub. No.: US 2026/0002235 A1
(43) Pub. Date: Jan. 1, 2026

(54) Method for Producing Rare Earth Metals via Thermite Reduction of Rare Earth Compounds with Aluminum

(71) Applicant: Maoqi Mark Feng, Richland, WA (US)

(72) Inventor: Maoqi Mark Feng, Richland, WA (US)

(73) Assignee: Polykala Technologies, LLC, San Antonio, TX (US)

(21) Appl. No.: 19/318,530

(22) Filed: Sep. 4, 2025

(51) Int. Cl. C22B 59/00; C22B 5/04; C22B 7/00; C22B 9/02; C22B 9/04; C22B 11/02; C22B 23/02; H01M 10/54

(52) U.S. Cl. CPC C22B 59/00; C22B 5/04; C22B 7/001; C22B 9/02; C22B 9/04; C22B 11/02; C22B 23/02; H01M 10/54

(57) ABSTRACT

A method and cascade reactor system for producing elemental rare earth metals and rare earth-aluminum alloys via aluminothermic reduction are disclosed. The method involves combining rare earth oxides or halide salts with aluminum powder, initiating a thermite-type reaction under inert or controlled atmospheric conditions, and recovering the molten metal product. Fluxing agents may be used to enhance slag fluidity and phase separation. The cascade reactor comprises multiple thermite zones with staged ignition, thermal transfer mechanisms, and slag separation interfaces, enabling sequential reduction of mixed feedstocks. The system supports both batch and continuous formats and achieves high recovery yields, reduced aluminum contamination, and compatibility with alloying and post-purification processes. The invention is adaptable to individual rare earth species and mixed oxide concentrates, offering a scalable, energy-efficient, and environmentally favorable route to rare earth metal and alloy production.

### FIELD OF THE INVENTION

This invention relates to the field of extractive metallurgy, specifically to thermite-type aluminothermic reduction processes for producing rare earth metals and alloys from rare earth oxides or halide salts. It further pertains to reactor systems configured for staged thermite reactions and post-reduction purification.

### BACKGROUND

Rare earth metals (REMs)—including the fifteen lanthanides, as well as scandium and yttrium—are indispensable to a broad spectrum of advanced technologies. Their unique electronic, magnetic, and structural properties make them critical components in permanent magnets, solid-state lasers, phosphors, rechargeable batteries, hydrogen storage systems, and high-performance alloys. Despite their relative abundance in the Earth's crust, REMs are rarely found in concentrated form. Instead, they occur in complex mineral matrices as oxides, carbonates, or halide salts, often intermingled with other metals. Their similar ionic radii and high thermodynamic stability render their extraction and purification both technically demanding and economically intensive.

High-purity REMs are essential for applications requiring exceptional reliability and performance, such as Nd—Fe—B and Sm—Co permanent magnets, precision optics, and specialty alloys. Conventional production methods include molten-salt electrolysis, electrolytic reduction of halide salts, and plasma-based oxide reduction. While these techniques can yield high-purity metals, they typically require specialized infrastructure, elevated energy input, and stringent operational control—factors that limit their scalability and cost-effectiveness for bulk production.

Aluminothermic reduction offers a mature, thermodynamically favorable alternative. Aluminum, being abundant and inexpensive, serves as a potent reductant for rare earth oxides and halide salts. Once initiated, the reaction is highly exothermic and self-sustaining, eliminating the need for continuous external heating. This makes the process attractive for large-scale synthesis of rare-earth—aluminum master alloys, which can be further refined via molten-salt electrolysis, vacuum distillation, or secondary metallothermic reduction to produce high-purity metals.

Compared to molten salt electrolysis—which is well-suited for light REMs like La, Nd, and Pr—aluminothermic reduction offers greater flexibility, lower infrastructure demands, and improved compatibility with alloying and small-batch synthesis. Calciothermic reduction, while more thermodynamically potent, introduces significant safety and handling challenges due to calcium's reactivity and cost. Emerging technologies such as the FFC-Cambridge process and ionic liquid electrolysis show promise for sustainability, but remain in developmental stages and lack the industrial maturity of aluminothermic methods.

Despite its advantages, conventional aluminothermic reduction faces persistent challenges. These include incomplete reduction of stable oxides (e.g., CeO₂, Dy₂O₃), uncontrolled temperature spikes due to exothermicity, and formation of unwanted intermetallic compounds. Impurities such as aluminum oxide (Al₂O₃) may entrap rare earth metals or contaminate the final product. Moisture and residual carbonates in the feedstock further complicate reaction pathways, especially in powder-based systems where surface area and diffusion rates critically influence kinetics.

Present invention addresses these limitations through a cascade thermite-based aluminothermic reduction method optimized for rare earth metal and alloy production. The process employs carefully balanced stoichiometry to regulate peak temperatures and minimize byproduct formation. Flux-assisted reduction using compounds such as CaF₂, CaCl₂), or cryolite lowers slag viscosity and enhances phase separation. Engineered containment strategies—including inert atmospheres, CO₂-assisted ignition, and closed crucible designs—improve safety and retention of volatile species. In certain embodiments, molten aluminum serves as both reductant and solvent, accelerating reaction kinetics and improving product purity. Pre-treatment of feedstock via calcination or mechanical activation increases surface area and removes volatile contaminants, further enhancing reduction efficiency.

Through this integrated approach, the invention achieves high recovery yields, reduced aluminum contamination, and improved slag mobility. It supports both batch and continuous formats, accommodates mixed oxide feedstocks, and enables direct production of rare earth alloys suitable for permanent magnets, getter materials, and catalytic applications. The method offers a scalable, energy-efficient, and environmentally responsible solution for rare earth metal extraction and alloy synthesis.

### SUMMARY OF THE INVENTION

The present invention relates to methods and systems for producing elemental rare earth metals and rare earth-containing alloys via aluminothermic reduction of rare earth oxides or halide salts. The process utilizes aluminum powder as a reductant and is conducted under inert or controlled atmospheric conditions to suppress contamination and maximize metal recovery. Unless otherwise specified, the terms “rare earth elements” or “rare earth metals”, and “REMs” are used interchangeably.

In one aspect, the invention provides a method for producing elemental rare earth metals comprising:
Mixing a rare earth oxide or halide salt with aluminum powder;
Initiating a thermite-type reduction reaction under an inert or controlled atmosphere; and
Recovering the elemental rare earth metal from the reaction product.

Aluminum powder preferably has a particle size below 100 μm and a purity of at least 99%. Suitable atmospheric conditions include argon, helium, carbon dioxide, or mixtures thereof. The reaction may be initiated using a magnesium strip ignition source, optionally under flowing CO₂ to generate localized heat while suppressing nitrogen or moisture contamination.

A fluxing agent—such as calcium fluoride (CaF₂), calcium chloride (CaCl₂)), cryolite (Na₃AlF₆), or calcium oxide (CaO)—may be added to enhance slag fluidity and facilitate separation of the molten metal phase from aluminum oxide slag. The aluminum-to-oxide ratio is adjusted to meet or slightly exceed stoichiometric requirements, thereby regulating peak reaction temperature and ensuring complete reduction.

Rare earth oxide feedstock may include CeO₂, La₂O₃, Nd₂O₃, Pr₆O₁₁, Sm₂O₃, Gd₂O₃, Dy₂O₃, or mixtures thereof. Upon reaction, the rare earth metal is collected as a molten phase beneath the slag layer and solidified after separation. Optional post-treatment steps—such as vacuum distillation, electrorefining, or secondary metallothermic reduction—may be employed to further purify the recovered metal.

In another aspect, the invention provides a method for producing rare earth metal alloys from mixed rare earth oxide feedstocks. The method comprises:
Mixing the feedstock with aluminum powder and optionally a fluxing agent;
Initiating a thermite-type reduction reaction under inert or controlled atmosphere; and—Recovering a rare earth alloy from the reaction product.

Mixed oxide feedstocks may include combinations of CeO₂, La₂O₃, Nd₂O₃, Pr₆O₁₁, Sm₂O₃, and Gd₂O₃. The resulting alloy may serve as a precursor for neodymium-iron-boron or samarium-cobalt permanent magnets, high-strength structural alloys, or catalytic materials. Aluminum is added in excess of the stoichiometric amount to ensure complete reduction of all oxide components.

A selective refining step may be used to isolate specific rare earth elements from the alloy. The fluxing agent is present in an amount sufficient to form a fully molten slag at peak reaction temperatures, typically between 1800° C. and 2100° C. The reaction is conducted in a refractory crucible—such as graphite, silicon carbide, or alumina—within a sealed chamber purged with inert gas.

Across all embodiments, the inventive process achieves:
High metal yield (typically 90-98% of theoretical content);
High purity (exceeding 98 wt %);
Rapid reaction times (under two minutes for small batches);
Operational flexibility for both batch and continuous production;
Reduced environmental impact compared to plasma-based or electrolytic methods.

By integrating optimized stoichiometry, tailored flux selection, contamination-free ignition, and controlled-atmosphere operation, the invention provides a scalable, efficient, and environmentally favorable route to rare earth metal and alloy production. The same principles may be adapted for recovery of non-rare-earth specialty metals such as cobalt and ruthenium.

Typical yields range from 90-98% of theoretical metal content, depending on feedstock purity, stoichiometry, and flux efficiency. For example, reduction of LaCl₃ with stoichiometric aluminum and 10 wt % CaF₂ flux under argon yields greater than 95% pure lanthanum metal. The process is compatible with both light and heavy lanthanides and supports single-batch reduction of mixed rare earth feedstocks to form master alloys, which may be refined to isolate individual elements.

In all embodiments, the combination of optimized aluminum stoichiometry, flux selection, inert atmosphere, and controlled ignition ensures efficient reduction, high metal purity, minimal slag contamination, and safe containment of volatile byproducts. The method is suitable for both small-scale specialty production and industrial-scale manufacturing.

By integrating advanced reaction chemistry, improved slag design, and controlled-atmosphere processing, the invention overcomes long-standing limitations of conventional aluminothermic methods. It offers a scalable, economically viable, and environmentally responsible solution for rare earth metal and alloy production. The disclosed methods also enable recovery of non-rare-earth specialty metals—such as cobalt and ruthenium—by applying the same metallothermic reduction principles. The combination of inert-atmosphere operation, efficient post-reaction separation, and reduced energy demand results in higher product purity, lower environmental impact, and improved process efficiency compared to conventional high-temperature reduction techniques.

### BRIEF DESCRIPTION OF THE DRAWINGS

Following detailed description, when considered in conjunction with the accompanying figures, provides a comprehensive understanding of the disclosed invention. These illustrations are provided for explanatory purposes only and are not intended to limit the scope of the invention. While specific features are depicted to enhance clarity, commonly known components may be omitted to focus on the inventive aspects. It is further recognized that alternative configurations and design modifications may be implemented without departing from the spirit or scope of the disclosed embodiments.

FIG. 1 is a schematic representation of a simplified thermite reaction system for rare earth metal production, in accordance with one embodiment of the invention.

FIG. 2 is a process flow diagram illustrating the thermite reaction sequence for rare earth metal extraction, as described in one embodiment.

FIG. 3 depicts a cascade thermite reactor configuration for staged rare earth metal production, as described in the disclosed invention.

FIG. 4 illustrates a multi-stage cascade thermite production process for rare earth metal extraction, including pre-treatment, staged reduction, slag separation, and purification steps.

### DETAILED DESCRIPTION OF INVENTION

Present invention pertains to an improved aluminothermic reduction process for producing high-purity rare earth metals (REMs) and rare earth-aluminum alloys from rare earth oxides or halide salts. This method addresses several limitations inherent in conventional reduction techniques, including the formation of intermetallic compounds, inefficient slag-metal separation, generation of volatile byproducts, and sensitivity to ambient atmospheric conditions. The disclosed process enables scalable, energy-efficient, and economically viable production of rare earth metals and alloys with enhanced purity and yield.

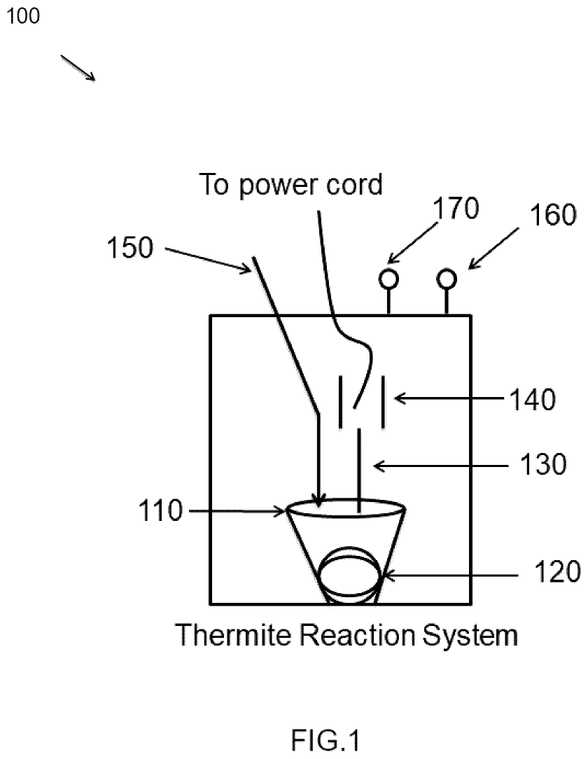

The thermite reaction system employed for rare earth metal production is a high-temperature metallothermic reduction process that converts rare earth oxides (REOs) into elemental metals using a reactive metallic reductant, most commonly aluminum. As illustrated in FIG. 1, the simplified thermite reaction system 100 comprises a thermite reaction container 110 (constructed from graphite or silicon carbide), reactant cakes 120 formed from powder mixtures, a magnesium ignition strip 130, a plasma arc ignition source 140, a carbon dioxide (CO₂) shielding line 150, and integrated temperature and pressure readouts 160 and 170, respectively. Prior to ignition, CO₂ is introduced into the system for approximately 30 minutes to displace ambient oxygen and create a controlled atmosphere. Cakes made from the reactant powder mixture—typically rare earth oxide such as Nd₂O₃ or Dy₂O₃ blended with fine aluminum powder in a stoichiometric ratio—are pelletized or loaded into a refractory-lined mold and placed inside the reaction container. A magnesium strip, measuring approximately 3-5 inches in length and 0.5 inches in width, is positioned near the plasma arc igniter. Upon ignition, the strip is released from its hanger and dropped into the container, initiating the highly exothermic thermite reaction. Once is triggered, the reaction proceeds violently but lasts only a few minutes. Throughout the process, temperature and pressure are closely monitored. After completion, the system is allowed to cool naturally for approximately one hour before the reaction products are collected from the container.

Ignition is initiated using a localized heat source, such as a spark, resistive coil, or magnesium ribbon, which triggers a highly exothermic thermite reaction. This reaction reduces the rare earth oxide to elemental metal while oxidizing aluminum to form alumina slag (Al₂O₃). Due to its higher density, the molten rare earth metal settles at the bottom of the reaction vessel, while the alumina slag floats above. After cooling, the slag is separated from the metal either by gravity decanting or mechanical scraping. The recovered metal may contain residual impurities, which are removed through post-purification steps such as acid leaching, vacuum distillation, or electrorefining. The final product is a dense, metallic rare earth button suitable for downstream applications including alloying, magnet fabrication, or getter integration.

During the mixing stage, the rare earth oxide is combined with stoichiometric or slightly excess quantities of aluminum powder. The mixture may be compacted into pellets or loaded into a refractory-lined crucible, depending on the intended reaction scale and ignition method. Upon application of a localized heat source—such as a magnesium ribbon, spark igniter, or resistive coil—the thermite reaction self-propagates, rapidly generating temperatures exceeding 2000° C. This intense thermal environment drives the reduction of the oxide to rare earth metal, while aluminum is oxidized to alumina slag.

Following completion of the reaction, the molten rare earth metal collects at the bottom of the crucible, and the alumina slag remains above. The system is allowed to cool, after which mechanical separation of the slag and metal is performed. Residual contaminants, including unreacted aluminum or oxide inclusions, may be removed via acid leaching or selective dissolution. For applications requiring ultra-high purity, further refining steps such as vacuum distillation, electrorefining, or zone melting may be employed.

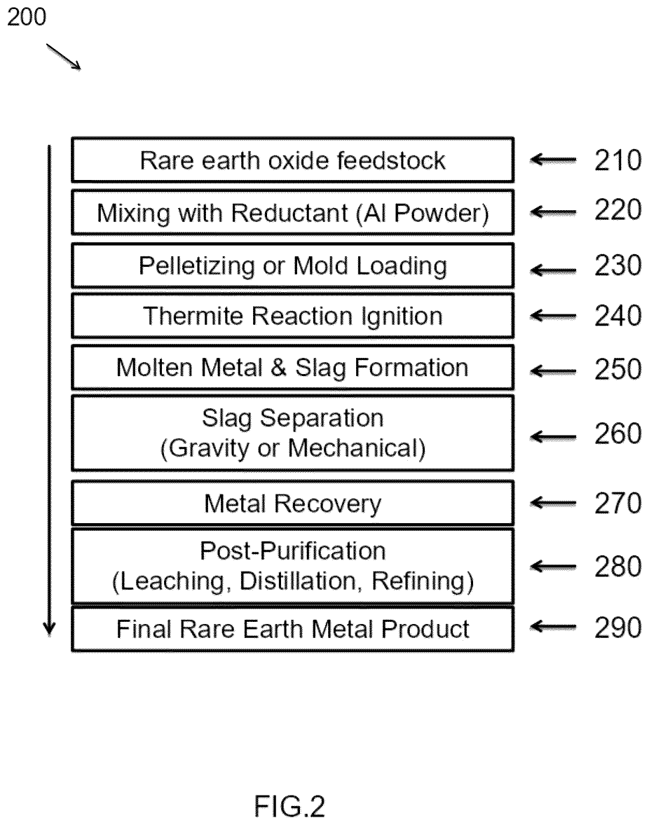

FIG. 2 illustrates the thermite reaction process 200 as a nine-step sequence: rare earth oxide feedstock 210, mixing with aluminum powder 220, pelletizing or mold loading 230, thermite reaction ignition 240, molten metal and slag formation 250, slag separation 260 (via gravity or mechanical means), metal recovery 270, post-purification 280 (leaching, distillation, refining), and final rare earth metal product 290. The process begins with purified rare earth oxide feedstock, which is mixed with aluminum powder in a stoichiometric ratio, pelletized or loaded into a mold, and ignited using a localized heat source. The resulting reaction produces molten rare earth metal and alumina slag, which are separated based on density.

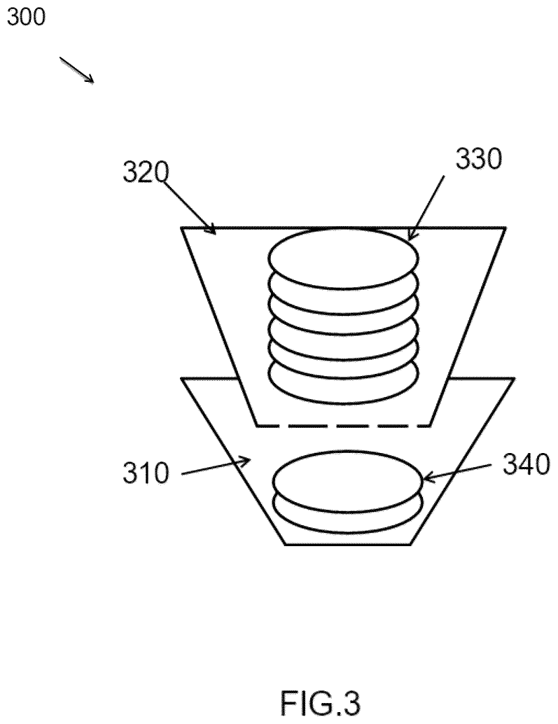

Thermite-based approach offers a scalable, solvent-free alternative to aqueous reduction methods, particularly well-suited for niche applications requiring high purity, localized production, or alloy integration. Its modular nature supports staged reactions, making it ideal for processing mixed rare earth oxides or tailoring reduction conditions for specific elements. This methodology can be further expanded into a cascade thermite production process, as illustrated in FIG. 3. The cascade system comprises a multi-zone reactor designed to perform sequential metallothermic reductions using aluminum as the reductant. Key components include a bottom reaction container 310 (constructed from graphite or silicon carbide), a top reaction container 320 (ceramic, bottomless, and fitted with a 10-20 mesh ceramic screen), reactant cakes 330, and layered powder mixtures or cakes 340. A piece of ashless filter paper is placed atop the ceramic mesh to support the reactants while allowing molten products to pass through.

In operation, distinct reactant mixtures are loaded into both the top and bottom thermite reaction containers. The top container is ignited using a magnesium strip, following the procedure described in FIG. 1. Once the thermite reaction in the top container is initiated, the resulting molten metal product drips through the filter assembly into the bottom container, where it serves as both heat source and ignition trigger for the second-stage reaction. This cascading ignition enables sequential reduction of multiple oxide layers with minimal external energy input. After the system cools to room temperature, the solidified products are collected from both containers for further analysis or purification.

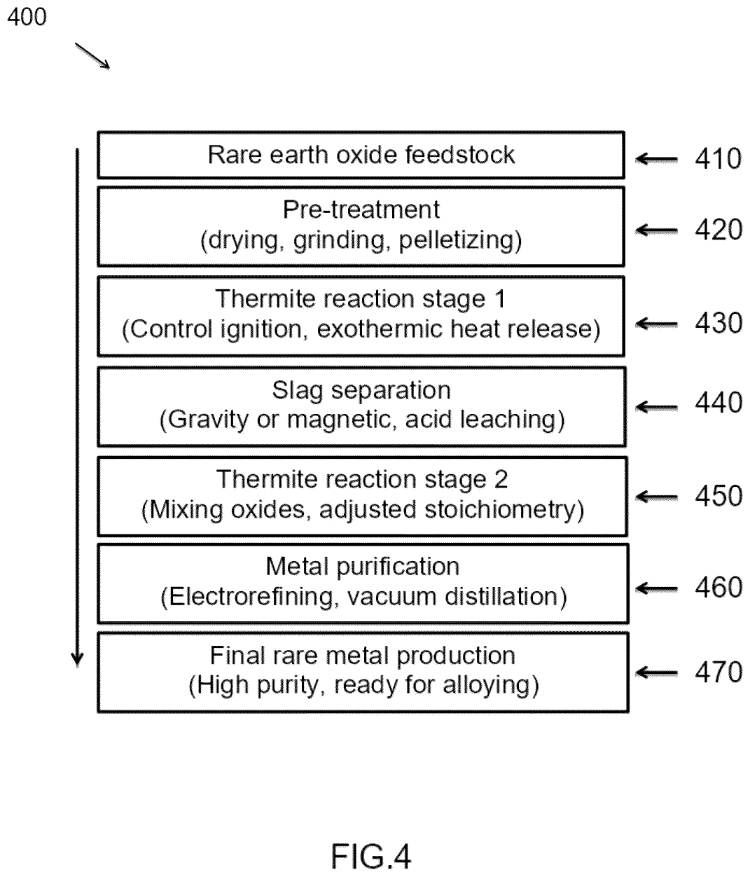

FIG. 4 presents a cascade thermite reaction process flow for rare earth metal extraction, divided into seven stages: rare earth oxide feedstock 410, pre-treatment (drying, grinding, pelletizing) 420, thermite reaction stage 1 (controlled ignition and exothermic heat release) 430, slag separation (via gravity, magnetic methods, or acid leaching) 440, thermite reaction stage 2 (processing mixed oxides with adjusted stoichiometry) 450, metal purification (electrorefining, vacuum distillation) 460, and final rare earth metal production 470 (high purity, ready for alloying). This multi-stage metallothermic reduction process enables successive thermite reactions using aluminum powder to convert rare earth oxides into elemental metals.

Cascade thermite production system comprises a multi-zone reactor configured to perform sequential metallothermic reductions of rare earth oxides using aluminum as the reductant. Each zone is thermally insulated and structurally isolated to allow discrete ignition and controlled reaction propagation. The system is engineered to optimize energy transfer, reduce cross-contamination, and enable selective recovery of rare earth metals from complex or mixed oxide feedstocks.

In operation, rare earth oxide and aluminum powder are proportioned and loaded into each reaction zone, either as compacted pellets or layered charges. The first zone is ignited using a localized ignition source, such as a resistive coil or pyrotechnic initiator. The resulting exothermic reaction reduces the oxide to elemental rare earth metal and generates alumina slag. The molten metal settles at the bottom of the zone due to its higher density, while the slag floats above, enabling efficient phase separation.

Thermal energy generated during the initial thermite reaction is partially transferred to adjacent reaction zones, either passively via conduction or actively through staged ignition control. Each subsequent zone undergoes an independent reduction cycle, enabling customized processing of distinct rare earth oxides or refinement of partially reduced intermediates. Slag separation is achieved through gravity decanting, mechanical scraping, or fragmentation following cooling. The resulting rare earth metal buttons are recovered and may be subjected to optional purification steps, including acid leaching, vacuum distillation, or electrorefining.

The cascade configuration provides modular control over reaction kinetics, thermal gradients, and product purity. This architecture is particularly beneficial for processing complex oxide mixtures, integrating alloying elements, and scaling production for high-value applications such as photonic packaging, getter fabrication, and strategic metal reserves.

The aluminothermic reduction process disclosed herein employs aluminum as a potent reductant to convert rare earth compounds—typically oxides (RE₂O₃) or halides (REF₃)—into their metallic forms. The rare earth feedstock is finely divided and blended with high-purity aluminum powder in stoichiometric or slightly excess proportions. To enhance reaction kinetics and improve slag-metal separation, fluxing agents such as calcium chloride or cryolite may be incorporated. The homogenized mixture is compacted into pellets or briquettes and loaded into a refractory crucible composed of materials such as graphite or alumina, capable of withstanding elevated temperatures. The reduction reaction is initiated by an ignition source, including but not limited to magnesium ribbon or localized electric arc, and proceeds in a self-sustaining manner due to its highly exothermic nature. Reaction temperatures may exceed 2000° C., sufficient to melt both the reduced metal and the slag. During the reaction, aluminum preferentially reacts with oxygen or halogens to form aluminum oxide (Al₂O₃) or aluminum halides (AlX₃, where X═F, Cl), thereby liberating the rare earth element in its metallic state.

Upon completion of the reaction and subsequent cooling, the dense rare earth metal settles at the bottom of the crucible, physically separated from the lighter slag layer. Mechanical separation or selective chemical leaching is employed to isolate the metallic product. This process is particularly advantageous for producing rare earth alloys, wherein transition metals such as iron (Fe), nickel (Ni), or cobalt (Co) may be co-reduced to impart desired magnetic or structural properties.

The process may be summarized as follows:-Preparation: Rare earth oxide or halide feedstock is mixed with a stoichiometric or slightly excess amount of aluminum powder. Flux is added in the range of approximately 5-15 wt % to promote slag-metal separation.
Reaction Setup: The mixture is loaded into a refractory crucible housed within a sealed reaction chamber purged with inert gas. Thermocouples are positioned to monitor temperature profiles.
Ignition: The reduction is initiated using a localized ignition source, such as a magnesium ribbon or electric arc. The reaction proceeds rapidly and exothermically, reaching peak temperatures of approximately 2000° C. without sustained external heating.
Phase Separation: The molten rare earth metal, being denser, accumulates at the bottom of the crucible, while the slag—comprising aluminum oxide or halide compounds—remains above.
Cooling and Recovery: Following natural cooling or accelerated quenching under inert gas, the solidified rare earth metal is mechanically separated from the slag.
Post-Treatment (Optional): The recovered metal may undergo acid washing, vacuum distillation, or other purification steps to remove residual slag, flux, or volatile contaminants.

Feedstock materials used in the process include rare earth oxides (RE₂O₃) and halide salts (e.g., REF₃, RECl₃), which may consist of single-element or mixed-element compositions. These materials are finely divided to maximize surface area and enhance reaction kinetics. Aluminum powder is blended in a stoichiometric or slightly excess ratio sufficient to fully reduce the rare earth species while maintaining controlled reaction temperatures.

When the halide salts are employed as feedstocks, the formation of volatile aluminum halides (e.g., AlCl₃, AlF₃) introduces operational challenges. These byproducts are corrosive, may entrain rare earth halides, and require appropriate gas handling and scrubbing systems. Additionally, the high reactivity of molten rare earth metals necessitates stringent atmospheric control to prevent formation of nitrides, hydrides, or carbides. Exposure to trace amounts of nitrogen, moisture, or carbon during processing must be minimized through rigorous feedstock drying and careful selection of crucible materials. Although aluminothermic reduction is thermodynamically favorable and cost-effective, these metallurgical and operational considerations must be addressed to ensure product quality.

In certain embodiments, a fluxing agent is incorporated to improve slag fluidity and facilitate separation of the metallic rare earth phase from aluminum oxide byproducts. Suitable fluxes include, but are not limited to, calcium fluoride (CaF₂), calcium oxide (CaO), and cryolite (Na₃AlF₆). The flux composition and dosage are optimized to minimize oxide inclusions in the recovered metal and to produce a uniform, low-viscosity slag.

The reduction reaction is conducted under an inert or controlled atmosphere, such as argon or carbon dioxide-assisted conditions, and initiated using a suitable ignition source. Acceptable ignition methods include magnesium strips, electric arc discharge, or localized resistive heating. Once initiated, the reaction proceeds spontaneously and generates sufficient thermal energy to complete the reduction without external heat input.

During the reaction, the rare earth metal forms a molten phase, which may contain minor amounts of dissolved aluminum. Separation from the slag is achieved via density-driven stratification and mechanical or thermal techniques. In certain embodiments, post-reduction refining is performed to remove residual aluminum or intermetallic compounds. Refining methods may include molten salt electrolysis, vacuum distillation, or secondary metallothermic reduction.

The disclosed aluminothermic reduction process is adaptable to both batch and continuous production formats. For mixed rare earth feedstocks, key reaction parameters—including temperature profiles, flux composition, and reductant ratios—can be selectively tuned to favor the recovery of specific rare earth elements or to produce uniform rare earth-aluminum master alloys suitable for downstream metallurgical applications.

This inventive method enables precise control over reaction temperature, product purity, and metal yield, while mitigating the formation and release of volatile aluminum halides and other undesirable byproducts. Safety and environmental compliance are achieved through the use of sealed reaction vessels, inert gas atmospheres, and integrated gas scrubbing systems designed to capture and neutralize volatile emissions generated during the reduction process.

During the reduction, the rare earth metal phase may incorporate minor quantities of dissolved aluminum, particularly in cases where rare earth-aluminum intermetallic compounds are formed. These intermetallics can be removed or converted through secondary refining techniques, including molten salt electrolysis, vacuum distillation, or additional metallothermic reduction. When halide feedstocks are used, volatile aluminum halides (e.g., AlCl₃, AlF₃) are produced and contained within the sealed reaction chamber, where they are subsequently neutralized using appropriate gas scrubbing systems.

An exemplary reaction illustrating the reduction of lanthanum chloride by aluminum is represented by the following stoichiometric equation:

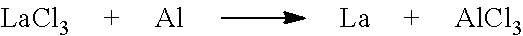

This reaction pathway is broadly applicable to other rare earth chlorides and fluorides, with analogous stoichiometric relationships governing the reduction of each compound.

Compared to conventional rare earth metal production techniques, the disclosed method offers several distinct advantages:
Eliminates the need for electrolysis or calcium-based reductions, thereby reducing operational hazards.
Operates at lower overall cost while remaining compatible with a wide range of rare earth species.—Achieves higher product purity when appropriate fluxes and protective atmospheres are employed.
Scales effectively for both batch and continuous production, making it suitable for industrial and specialty applications.

Thermite-type reaction is initiated using a localized ignition source, such as a magnesium ribbon or electrical arc. Once triggered, the reaction proceeds in a self-sustaining manner due to the highly exothermic nature of the aluminothermic reduction.

Upon completion of the reaction, the denser rare earth metal settles at the bottom of the crucible, while the slag—comprising aluminum oxide, residual flux, and aluminum halide compounds—remains above. Cooling may be achieved through natural convection or accelerated quenching using inert gas. The solidified metallic phase is then mechanically separated from the slag layer.

Optional post-treatment steps may be employed to further purify the recovered rare earth metal, including:
Acid washing to remove entrapped slag or residual flux.
Vacuum distillation to eliminate low-melting contaminants.
Secondary metallothermic reduction to decompose RE-AI intermetallic compounds, if present.

The efficient production of high-purity rare earth metals and RE-AI alloys via aluminothermic reduction depends critically on the preparation and utilization of aluminum powders with desirable particle size and morphology. Aluminum serves both as the reductant and, optionally, as a component of the alloy phase. Its reactivity is influenced by surface area, oxide film characteristics, and mixing behavior. Preferred aluminum powders have a particle size below 100 μm and a purity of at least 99%. High surface area promotes rapid reaction kinetics, while controlled oxide film thickness prevents excessive passivation or incomplete reduction. To improve slag fluidity and facilitate phase separation, optional fluxes may be incorporated, including calcium fluoride (CaF₂), sodium chloride (NaCl), or magnesium chloride (MgCl₂). The reaction is conducted under a protective atmosphere—such as high-purity argon or nitrogen—to minimize contamination by oxygen, nitrogen, or hydrogen.

Method of aluminum powder preparation significantly influences reaction efficiency, metal yield, and final product purity. Gas atomization is preferred for high-purity applications, as it produces spherical particles with clean surfaces and minimal oxide content, offering excellent flowability and uniform mixing with rare earth feedstocks. In contrast, water atomization yields irregular particles with higher surface area, which may enhance reactivity but also increase oxide formation. Additional flux may be required to compensate for this oxide layer. Ball milling or stamp milling techniques produce flake-like or irregular particles with extremely high surface area, accelerating reaction kinetics for refractory oxides. However, these powders are more susceptible to oxidation and handling hazards, making them better suited for small-batch or inert-atmosphere operations.

For specialized laboratory-scale or ultra-high-purity applications, aluminum powders may be produced via electrolytic deposition, yielding dendritic morphologies characterized by exceptional purity and high surface activity. These powders exhibit rapid ignition and enable complete reduction at lower initiation temperatures. However, their elevated reactivity necessitates stringent control of moisture and oxygen during storage and handling. In practice, the selection of aluminum powder preparation method involves trade-offs among particle morphology, oxide content, handling safety, and cost. Gas-atomized spherical aluminum powders in the 40-60 μm range often provide the optimal balance for scalable, efficient, and clean aluminothermic production.

Aluminum particle size is a critical parameter influencing reactivity, handling safety, and product yield in aluminothermic reduction. Powders below 100 μm are generally preferred, with the 20-80 μm range offering an optimal compromise for large-scale operations. Finer powders (<20 μm) possess high surface area, accelerating reaction rates and lowering ignition thresholds, but they are prone to rapid oxidation, pose greater handling hazards, and may generate excessive heat that complicates slag-metal separation. Coarser powders (>75 μm) are more stable and easier to handle but may reduce reaction efficiency due to slower kinetics and incomplete feedstock conversion. Selecting an appropriate particle size ensures controlled reaction profiles and maximized reduction completeness.

Beyond particle size, shape and surface characteristics significantly affect process performance. Spherical powders—typically produced via gas atomization—exhibit superior flowability and packing behavior, promoting intimate contact between aluminum and rare earth feedstocks while reducing slag entrapment. Irregular or flake-shaped powders, often derived from milling, offer increased surface area and reactivity but may result in uneven mixing and elevated slag viscosity, hindering clean separation. The native aluminum oxide (Al₂O₃) film on powder surfaces is unavoidable but should be minimized; powders produced and stored under inert gas conditions exhibit reduced oxide thickness, enhancing reduction efficiency. Tailoring both particle size and morphology to the specific feedstock and process conditions is essential for achieving high-purity, high-yield production. This step is among the most critical determinants of reaction efficiency and product quality.

For industrial-scale aluminothermic reduction, selecting aluminum powder with particle sizes below 100 μm ensures a balance between reactivity and safe handling. Gas-atomized spherical particles support consistent flow, uniform mixing, and predictable ignition behavior while minimizing oxide contamination. Although irregular or flake powders may accelerate reaction kinetics, they are more difficult to handle and may trap slag within the final metal product. Aluminum purity above 99% is preferred to avoid introducing extraneous elements into the rare earth metal.

Preparation and handling of aluminum powder are as critical as the reduction reaction itself. The process typically begins with the selection of high-purity aluminum powder-preferably gas-atomized spherical particles under 100 μm—to ensure consistent reactivity and mixing. Rare earth oxide or halide feedstocks are thoroughly dried under vacuum or inert gas to eliminate adsorbed moisture, which could otherwise lead to premature oxidation or hydrogen generation. The aluminum powder is blended with the feedstock and a flux such as CaF₂, NaCl, or cryolite under an inert atmosphere, typically within a glovebox, to prevent oxidation and ensure homogeneity. The flux lowers slag melting temperature, promotes metal-slag separation, and may assist in dissolving the native alumina film on aluminum particles.

The aluminothermic reaction is initiated by localized heating or an ignition mixture, often comprising finer aluminum powder and an oxidizer such as potassium perchlorate (KClO₄) to ensure rapid heat buildup. Once ignited, the reaction becomes self-sustaining, generating sufficient thermal energy to melt both the rare earth metal (or alloy) and the slag. Slag-metal separation is achieved either by tapping the molten phases or allowing stratification within a refractory-lined crucible, where the denser rare earth metal settles beneath the lighter slag. The solidified metal is then recovered. For ultra-high-purity applications, post-reduction refining—such as vacuum distillation—may be employed to remove residual aluminum or volatile impurities. Each step, from powder selection to refining, is tightly linked to aluminum powder properties, making particle size, shape, and surface condition central to process efficiency and product quality.

Particle size and shape directly influence the kinetics, yield, and purity of aluminothermic reduction. Finer powders offer increased reactive surface area, enabling faster reduction and lower ignition temperatures, but they oxidize rapidly, pose greater handling risks, and may produce excessive heat that disrupts slag-metal separation. Coarser powders are more stable and easier to handle but may result in incomplete reduction. Particle shape affects mixing and separation: spherical particles promote uniform packing and clean separation, while irregular or flake-like particles enhance reactivity but may cause uneven mixing and slag entrapment. Achieving the optimal balance of size and morphology ensures controlled reaction rates, high reduction completeness, and minimal contamination in the final product.

Aluminothermic reduction is a high-temperature metallothermic process wherein aluminum acts as the reductant to convert rare earth oxides or halide salts into metallic form. For oxide feedstocks, the reaction is strongly exothermic due to aluminum's high affinity for oxygen. A representative reaction is:

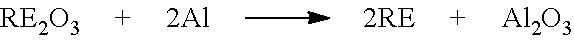

In practice, finely divided rare earth oxide is mixed with aluminum powder and a flux such as CaF₂ or CaO to reduce slag viscosity and facilitate separation. The charge is pelletized or briquetted, placed in a refractory-lined crucible under inert atmosphere or vacuum, and ignited via thermite-style initiation or external heating. The resulting heat melts both the metal and slag phases, allowing separation by density. Due to the tendency of rare earth metals to form intermetallic compounds with aluminum (e.g., REAl₂, REAl₃), the primary product is typically a rare earth-aluminum master alloy rather than pure metal.

For halide feedstocks such as RECl₃ or REF₃, aluminum reduces the rare earth cation while forming volatile aluminum halides (AlCl₃ or AlF₃), which may help drive the reaction forward. However, side reactions and the strong alloying tendency of rare earths with aluminum complicate the isolation of pure metal. The molten salt medium must be carefully managed to prevent back-reactions, contamination, and equipment corrosion.

Because direct aluminothermic reduction rarely yields high-purity rare earth metal, post-reduction purification is often necessary. Techniques may include molten salt electrorefining, wherein the RE-Al alloy serves as the anode and pure rare earth metal is deposited at the cathode, or secondary metallothermic reduction using calcium or magnesium to displace aluminum and reduce oxide inclusions. Despite these challenges, aluminothermic reduction remains attractive due to its high exothermicity, low cost of aluminum, and ability to produce master alloys directly. However, issues such as intermetallic formation, slag-metal separation, and residual aluminum removal must be addressed to achieve high-purity metal products.

Once the thermite charge is prepared, the crucible is preheated to a temperature range of approximately 800-1000° C. to mitigate thermal shock and facilitate reliable ignition. The aluminothermic reaction is initiated in a thermite-style configuration, typically using a starter charge or resistive heating element. The reaction is highly exothermic, rapidly elevating the internal temperature to 1500-1700° C., sufficient to melt both the rare earth product and the slag. Due to the strong affinity of rare earth metals for aluminum, the initial metallic product typically forms as a rare earth-aluminum master alloy, comprising intermetallic compounds such as REAl₂ and REAl₃. The aluminum oxide (Al₂O₃)-rich slag, rendered more fluid by flux additives, floats above the dense alloy and may be tapped or mechanically separated following cooling.

The resulting master alloy may be used directly in applications where aluminum-containing compositions are acceptable, such as alloying additions for steel, aluminum, or magnesium systems. When high-purity rare earth metal is required, further refining is performed. Refinement techniques include molten salt electrorefining, wherein the RE-Al alloy serves as the anode and high-purity rare earth metal is deposited at the cathode, or secondary metallothermic reduction using calcium to displace aluminum. Selective chlorination may also be employed to volatilize aluminum as AlCl₃; however, this method requires precise control to prevent undesired reaction with the rare earth metal. Throughout all stages of processing, strict atmosphere control is essential to prevent contamination by oxygen, nitrogen, or hydrogen, which readily react with rare earth metals at elevated temperatures.

Because direct aluminothermic reduction rarely yields high-purity rare earth metal, post-reduction purification is typically necessary. This may involve molten salt electrorefining or secondary metallothermic reduction using calcium or magnesium to displace aluminum and eliminate oxide inclusions. Despite these challenges, the aluminothermic method remains attractive due to its high exothermicity, low cost of aluminum, and ability to produce rare earth-aluminum master alloys directly. Nonetheless, issues such as intermetallic formation, slag-metal separation, and residual aluminum removal must be carefully managed to achieve high-purity metal products.

Alloy Production and Purification: When mixed rare earth oxide (REO) feedstocks are used, the resulting alloy composition reflects the input ratios of the constituent oxides. Post-reduction refining may be conducted using:
Vacuum distillation, which selectively removes volatile rare earths such as cerium (Ce) and lanthanum (La);
Electrorefining, which purifies targeted rare earths to metallurgical grade.

This approach enables direct production of rare earth permanent magnet alloys-such as neodymium-iron-boron (Nd—Fe—B) precursors-through a single-step reduction followed by selective refining. The aluminothermic reduction method is particularly well-suited for rare earth oxides and halide salts that are difficult to reduce via conventional electrochemical techniques.

### Integration of Examples into Detailed Description

Example 1—Thermite Reaction Applications in Rare Earth Metal Separation Mixtures of Nd₂O₃/Fe₂O₃ and Sm₂O₃/Co₂O₃ were derived from commercial NdFeB and SmCo magnets. The magnets were demagnetized via hydrogen treatment, and surface coatings were removed by sieving through a 100-mesh screen. Fine powders (20 g) were dissolved in 100 mL of 5 M hydrochloric acid at 60° C. for one hour. Water and excess acid were evaporated at 80° C. in two hours. The resulting solid mixtures were used as feedstock for thermite reduction, enabling separation of rare earth elements (REEs) from transition metals.

### Example 2—Thermite Reaction Baseline Experiments

Pure metal oxides including Fe₂O₃, NiO, CoO, CuO, and WO₃ were blended with aluminum powder (25 μm particle size). The reaction mixture was loaded into a SiC or graphite crucible (5-inch outer diameter, 4-inch inner diameter, 6-inch height). A molar ratio of metal oxide to aluminum of 1:2.5 was used. Each charge contained 5 g of metal oxide and 2.1-2.8 g of aluminum powder. Ignition was achieved using a burning magnesium strip, and reactions completed within 20-50 seconds. Post-reaction, cobalt metal was successfully separated using NdFeB magnet, demonstrating applicability to metal recovery from lithium-ion battery waste.

### Reaction Stoichiometry and Temperature Control

The molar ratio of aluminum to oxygen or halide content was selected to ensure complete reduction while avoiding excessive thermal runaway. A 1-10% excess of aluminum was used to drive the reaction to completion. Ignition methods included resistance heating, ignition wires, magnesium strips, and chemical igniters. Fluxing agents such as calcium fluoride (CaF₂), cryolite (Na₃AlF₆), calcium chloride (CaCl₂)), and alkali halides were incorporated to reduce slag viscosity, enhance phase separation, and capture impurities. Reactions were conducted under inert or controlled atmospheres—argon, nitrogen, carbon dioxide, or vacuum—to suppress oxidation and retain volatile rare earths. For highly reactive species, containment strategies included closed crucible designs, bottom-drain crucibles, and secondary condensation traps.

### Example 3—Magnesium Ignition in CO₂ Atmosphere

Among various ignition methods tested—including propane lighters and glycerol-KMnO₄ mixtures-magnesium strip ignition under CO₂ proved most effective. Magnesium combusts in CO₂ via the reaction:

2 Mg+CO₂→2MgO+C CO₂ was supplied from a pressurized cylinder, and the magnesium strip was ignited with a butane burner and introduced into the crucible under CO₂ flow, producing intense light. Literature indicates the reaction proceeds in two steps:

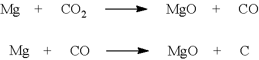

The second step yields condensed carbon particles, which enhance product purity in thermite reactions conducted under CO₂.

### Example 4—Parallel Thermite Reactions

To improve throughput, four crucibles were preloaded with thermite mixtures and ignited sequentially using magnesium strips. All reactions were completed within five minutes, demonstrating the scalability and operational efficiency of the process.

### Example 5—Rare Earth Oxide Thermite Reaction Experiments

Commercial rare earth oxides (REOs) were tested under conditions similar to baseline thermite reactions. Nd₂O₃, La₂O₃, Dy₂O₃, and Sm₂O₃ did not ignite, consistent with thermodynamic predictions. CeO₂ reacted with aluminum and iron oxide to form Ce—Al and Ce—Fe—Al alloys, which exhibited promising mechanical and casting properties. Further experiments demonstrated successful ignition of Nd₂O₃ and Sm₂O₃ using aluminum powder and magnesium strips as co-reductants.

### Example 6—Alumina Separation from Thermite Mixture

Following the thermite reaction, aluminum is converted to alumina (Al₂O₃), which may be separated via alkaline leaching. Aluminum hydroxide dissolves in sodium hydroxide to form soluble sodium aluminate:

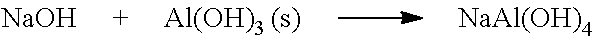

Thermodynamic mass balance indicates that approximately one-third of the sodium hydroxide reacts with alumina during leaching, enabling efficient removal of aluminum byproducts.

### Example 7—Noble Metal Recovery Via Thermite Reaction

To demonstrate process versatility, a waste catalyst containing 5 wt % ruthenium oxide supported on alumina was successfully reduced, yielding high-purity ruthenium metal within two minutes. A similar approach applied to a catalyst containing 3 wt % cobalt oxide resulted in efficient cobalt recovery in two minutes.

### Example 8—Magnesium Ignition Under CO₂ Atmosphere

Ignition using magnesium strips under a CO₂ atmosphere proved effective for high-purity metal production. CO₂, inert to most metals, supports magnesium combustion via:

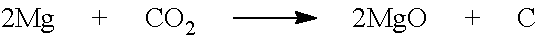

Comparative tests conducted without flux resulted in increased slag viscosity, reduced neodymium recovery (84%), and elevated aluminum contamination.

### Example 9—Rare Earth Oxide Reduction with Flux

Optimization Dy₂O₃ reduced with aluminum and cryolite flux achieved 97.1% yield and 99.1% purity. Sm₂O₃ reduced with aluminum and CaCl₂) flux achieved 97.1% yield and 98.9% purity. Mixed rare earth oxide concentrate reduced with aluminum, CaF₂, and cryolite produced a homogeneous alloy with approximately 95% recovery. Optional vacuum distillation enabled separation of Ce and La from Nd—Pr—Sm fractions.

### Laboratory-Scale Demonstration

### Example 10—Neodymium Metal Production from Nd₂O₃

To produce elemental neodymium (Nd) via aluminothermic reduction, the following materials were used:
Nd₂O₃: 50 g (99.9% purity, <75 μm)
Al powder: 18.2 g (99.7% purity, <45 μm)
Molar ratio: 1:2, with 10% excess aluminum
CaF₂: 5 g (fluxing agent)
Argon gas: oxygen content <10 ppm

### Apparatus and Procedure

A graphite crucible (120 mL) was placed in a vacuum/inert-atmosphere tube furnace equipped with an induction coil for localized heating. A Type C thermocouple was embedded near the reaction site, and a protective refractory lid with gas inlet/outlet was installed. The Nd₂O₃, aluminum powder, and CaF₂ were dry-mixed in a glove box under argon. The furnace chamber was purged with argon for 30 minutes at 0.5 L/min. The mixture was heated via induction until ignition at approximately 950° C. Peak temperature reached ˜2200° C. within 5-7 seconds. The reaction completed in ˜90 seconds and was cooled under argon. The product separated into a dense metallic button (Product A) and a brittle, glassy slag layer composed of Al₂O₃ and CaF₂.

### Results

Recovered metallic product: 32.6 g
Theoretical Nd yield: 33.8 g
Recovery efficiency: ˜96.5%-
XRD confirmed metallic neodymium phase

### ICP-MS Analysis:

Neodymium: 99.4 wt %
Aluminum: <0.2 wt %—Oxygen: <0.1 wt %—Other rare earths: <0.05 wt %

Observations No significant aluminum entrainment was detected in the metal phase. The flux improved slag separation and surface quality. The resulting neodymium metal was machinable and ductile following minor post-processing.

These examples collectively demonstrate that the disclosed invention enables:
Recovery yields exceeding 95%
Aluminum contamination below 0.6 wt %
Enhanced slag mobility and phase separation
Compatibility with individual oxides and mixed concentrates
Reduced environmental impact and energy consumption.

What is claimed is:

1. A method for producing an elemental rare earth metal from a rare earth oxide or halide salt, the method comprising:
providing a mixture comprising the rare earth oxide or halide salt and aluminum powder;
initiating a thermite-type reduction reaction using an ignition source under an inert or controlled atmosphere; and
recovering the elemental rare earth metal from the reaction product.

2. The method of claim 1, wherein the aluminum powder has a particle size of less than 100 μm, and preferably less than 60 μm, to enhance reaction kinetics and mixing uniformity.

3. The method of claim 1, wherein the inert or controlled atmosphere comprises argon, helium, carbon dioxide, or a mixture thereof.

4. The method of claim 1, wherein the ignition source comprises a magnesium strip.

5. The method of claim 4, wherein the magnesium strip is ignited in the presence of flowing carbon dioxide to suppress contamination from nitrogen and moisture.

6. The method of claim 1, further comprising incorporating a fluxing agent selected from calcium fluoride (CaF₂), calcium chloride (CaCl₂)), cryolite (Na₃AlF₆), calcium oxide (CaO), or mixtures thereof.

7. The method of claim 6, wherein the fluxing agent promotes separation of the rare earth metal phase from aluminum oxide slag.

8. The method of claim 1, wherein the aluminum is present in a stoichiometric or slightly excess amount, sufficient to complete reduction while minimizing intermetallic formation.

9. The method of claim 1, wherein the rare earth oxide is selected from CeO₂, La₂O₃, Nd₂O₃, Pr₆O₁₁, Sm₂O₃, Gd₂O₃, Dy₂O₃, or mixtures thereof.

10. The method of claim 1, wherein the recovered rare earth metal is further purified by vacuum distillation, electrorefining, or secondary metallothermic reduction.

11. The method of claim 1, wherein the rare earth metal is collected as a molten phase beneath a slag layer and solidified after separation.

12. A cascade thermite reactor system for producing rare earth metals from rare earth oxides, comprising:
a plurality of thermite reaction zones arranged in a sequential configuration within a thermally insulated reactor body, each reaction zone containing a charge comprising a rare earth oxide and a reductant material;
an ignition control system configured to initiate a thermite reaction in a first reaction zone;
a thermal transfer mechanism configured to propagate heat from the first reaction zone to at least one adjacent reaction zone to facilitate staged ignition;
a slag separation interface within each reaction zone configured to separate molten rare earth metal from slag based on density differences; and
a purification module configured to receive the separated rare earth metal and perform at least one purification process selected from acid leaching, vacuum distillation, or electrorefining.

13. The system of claim 12, wherein the reductant material comprises aluminum powder in stoichiometric or excess proportion relative to the rare earth oxide.

14. The system of claim 12, wherein the ignition control system comprises a resistive coil, sparking initiator, or pyrotechnic ignition layer.

15. The system of claim 12, wherein the thermal transfer mechanism comprises a conductive refractory partition positioned between adjacent reaction zones.

16. The system of claim 12, wherein the slag separation interface comprises a gravity decanting channel or mechanical scraping device.

17. The system of claim 12, wherein the purification module includes a vacuum chamber configured for distillation of volatile impurities from the rare earth metal.

18. The system of claim 12, wherein at least one reaction zone includes an alloying compartment configured to introduce a secondary metal during the thermite reaction.

19. The system of claim 12, wherein each reaction zone is configured to operate independently under programmable ignition timing and thermal feedback control.

20. The system of claim 12, wherein the reactor is configured to process mixed rare earth oxide feedstocks to produce rare earth metal alloys suitable for permanent magnets, high-strength alloys, or catalytic materials.
